(19) United States
(12) Patent Application Publication
(10) Pub. No.: US 2005/0120382 A1
(43) Pub. Date: Jun. 2, 2005

(54) System and method of remotely controlling a TV tuner over a TCP/IP network

(75) Inventor: Shitian Tang, Richmond (CA)

Correspondence Address: MARSHALL, GERSTEIN & BORUN LLP, 6300 SEARS TOWER, 233 S. WACKER DRIVE, CHICAGO, IL, 60606, US

(73) Assignee: TELEVIEWER SYSTEMS LTD., Richmond (CA)

(21) Appl. No.: 10/998,495

(22) Filed: Nov. 29, 2004

Related U.S. Application Data
(63) Continuation of application No. PCT/CN03/00941, filed on Jul. 11, 2003.

(51) Int. Cl. H04N 7/16; H04H 9/00; H04N 7/173

(52) U.S. Cl. 725/109; 725/112; 725/113; 725/110

(57) ABSTRACT

A system and a method of remotely controlling a TV tuner over a TCP/IP network is described. The system includes a client module and a host module, which are connected to each other through the Internet. The host module has a TV tuner device such as AGP/PCI TV card or USB TV Box installed. The client module has a simulation GUI of a TV. The client module sends a control command to the host module and renders a video/audio data stream feed by the host module. The method includes: the client module encodes the control command and sends it to the host module over the Internet. The host module receives the control command, decodes it, gets the related control instruction; and then operates the TV tuner to implement the related function and to generate new content video/audio stream for the client. The client renders the video/audio stream.

### CROSS-REFERENCE TO RELATED APPLICATIONS

This application is a continuation of International Application No. PCT/CN03/00941 filed Jul. 11, 2003.

### TECHNICAL FIELD

This patent generally relates to the communication field and especially to a system and method of controlling a TV Tuner device over TCP/IP network.

### BACKGROUND

With the development of information electrical appliances and corresponding multimedia technology, domestic electric information appliances are becoming nearly irresistible. Moreover, rapid development of network technology has provided a new medium for traditional television transmission—The Internet. Many kinds of network TV subject matter arise at historic moments. Current technology for network TV is named TV program buffering in that it captures the TV programs, saves it to the hard disk of the web server, and the visitors log on to the server to watch those program by streaming technology. There are many disadvantages to this technology. For instance it consumes a very large amount of hard disk space, the timeliness is poor and the visitor cannot change the TV channel.

### BRIEF DESCRIPTION OF THE DRAWINGS

FIG. 1 illustrates a system connection diagram of an embodiment of the invention;

FIG. 2 illustrates module structures of the host module;

FIG. 3 illustrates module structures of the client module;

FIG. 4 illustrates a TV tuner simulation;

FIG. 5 illustrates communication stacks of an embodiment of the invention;

FIG. 6 is a flow chart of an embodiment of the invention;

FIG. 7 is a flow chart of the client module;

FIG. 8 is a flow chart of the host module.

### DETAILED DESCRIPTION

In accordance with an embodiment of the invention, a TV tuner remote controlling system contains a host module and a client module, which are logically connected using a TCP/IP protocol.

The host module may run in a computer system with TV tuner device installed, a PCI/AGP TV card or external USB TV Box. The TV tuner device connects to CATV, cable TV, satellite TV or a broadcast TV antenna, and encodes the TV audio video signal and sends them to the client module. The host module also receives the control commands from the client module and issues those commands to the TV tuner, i.e., instructs the TV Tuner do the related operations.

The client module is able to play a video/audio stream from the host module and is able to send control commands to the host module over the Internet. That is, the host module and client module communicate to each other using a TCP/IP protocol.

Further, the host module may contain:

A socket transmitter module, data encoder/decoder module and a TV Tuner control module. The socket transmitter module receives the control commands from the client module and passes those commands to the encoder/decoder module. It is also responsible to send video and audio streams to the client module via the TCP/IP network.

A data encoder/decoder module that decodes the commands from the socket transmitter module. It also encodes the TV program signal into the audio and video streams.

A TV Tuner control module that may be driven by DirectShow, this control module is responsible to issue the decoded commands to the TV tuner hardware to complete the related operation. It also reads the TV program signal from the TV tuner and forwards the data to the data encoder/decoder module.

The client module may also include a TV simulation GUI module, the data encoder/decoder module and the socket transmitter module. The TV simulation GUI module simulates the functions of a TV and enaboes a user to input all kinds of control commands and render the video/audio streams.

The data encoder module encodes the control commands and assembles the data into a datagram. This allows the socket transmitter module to send them to the host module. It also decodes the video/audio streams data from the host module.

The socket transmitter module sends the control commands to the host module and receives the video/audio stream data from host module over the TCP/IP network, i.e., the Internet.

The control commands may include TV channel scanning, channel switching, channel increasing and channel decreasing or combinations of them.

The antenna could be the TV signal source from cable, CATV, satellite or an ordinary TV antenna or microwave TV signal source.

In another embodiment of the invention, a method of controlling a TV Tuner over a TCP/IP network may include:
encoding: a client module encodes control commands;
transmitting: the client module sends the encoded commands to a host module over the Internet;
decoding: the host module gets the commands and decodes them;
executing: the host module operates the TV Tuner according the commands and sends the new video/audio stream to the client module over a TCP/IP network, e.g. the Internet; and
rendering: the client module renders the new video/audio stream feed by the host module;

The methods may also involve the following:
confirmation: after the host module finished the demand operation, it sends a confirmation message to the client.

The confirmation message may contain a flag that shows whether the previous operation is successful or not.

The commands may be transferred by a Command Protocol (CP) datagram.

The network media between the host module and the client module can be wired or wireless.

The host module may work as follows:
Initialization: initialize the DirectShow component; find out the moniker of the capture card with TV tuner input;
Construction: create the CaptureBuild2 and create the graph of the captured video;
Binding: bind the moniker of the capture card to the capture filter;
Adding: add the capture filter to the graph;
Retrieving: find out the control interface (IID_IAMTVTuner) of the TV tuner;
Socket creating: create a server socket and start to listen to the connection from client; and
Responding client request: if there is a connection to the client, run the graph and stream the encoded video/audio to the client. If a control command is received from the client, call the related methods of the TV control interface to do the operation.

Systems and methods in accordance with embodiments of the invention provide a solution for remote TV tuning over an IP network. They have the merits of real-time and comprehensive. The client can receive all channels available on the host side, and the limitations of the TV standards are erased when the host and client locate in different countries with different TV standards.

The system and method are easy to operate, extend the operations of a TV tuner by using the TCP/IP network, increase the value of the TV capture device, and eliminate distance barriers that all operations have to be provided locally and/or manually.

The system and method are easy to implement. The hardware used in this invention is very common, and the operation systems are common as well. The implementer only needs the knowledge of the network communication and programming skill on DirectShow to implement the invention.

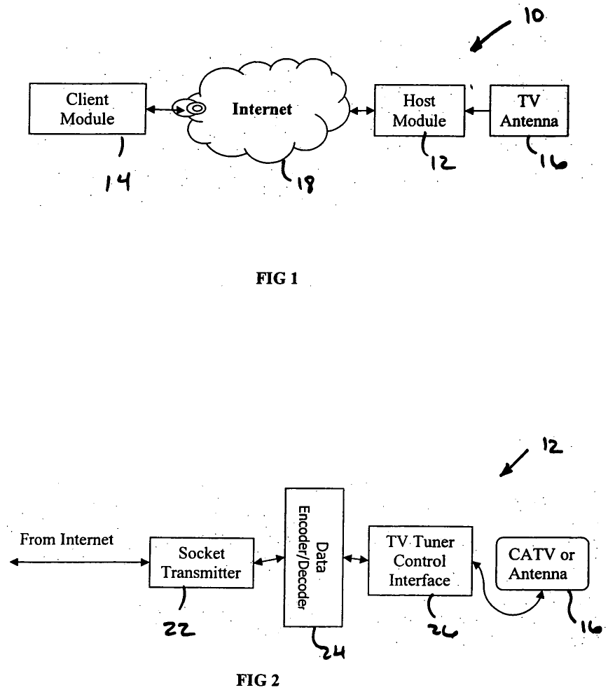

FIG. 1 illustrates an embodiment of the invention of a remote control system 10 for a TV tuner using a TCP/IP network. FIG. 1 shows two different modules within the system: a host module 12 and a client module 14. The host module may run on an operation system (05) that supports Direct X8.0 or later. The OS may be Microsoft Windows such as-Windows 98/ME/2000/XP/2003 or later. The host module computer also has a TV tuner device installed and the TV tuner is connected to the cable TV, CATV, satellite or antenna 16.

The client module runs on the OS, which supports TCP/IP. Again, the OS may be Microsoft Windows, but may be Unix, Linux, Mac OS or the embedded OS such as Windows CE, Palm OS, OS9000.

The host 12 and client 14 modules are connected over a network 18, such as the Internet. The connection media may be wired or wireless, depending on the actual environment and conditions.

FIG. 2 shows the structure of the host module. It shows the host module includes: a socket transmitter module 22, a data encoder/decoder module 24, and a TV tuner control module 26. The socket transmitter 22 talks to the network 18, e.g., the Internet. It receives the command from the client side 14, and sends the encoded video/audio streams to the client 14. The data encoder/decoder 24 does two things, one is to decode the control commands from the client module 14, to tell the module to do the related operation. The other one is to encode the TV program signal into a video/audio stream and to let the socket transmitter module 22 send it to the client 14 over the Internet 18. The TV tuner control module 26 receives the audio/video signal and passes the signal to the data encoder/decoder module 24 to encode. It also operates the TV tuner device 26 according the decode commands from the client 14.

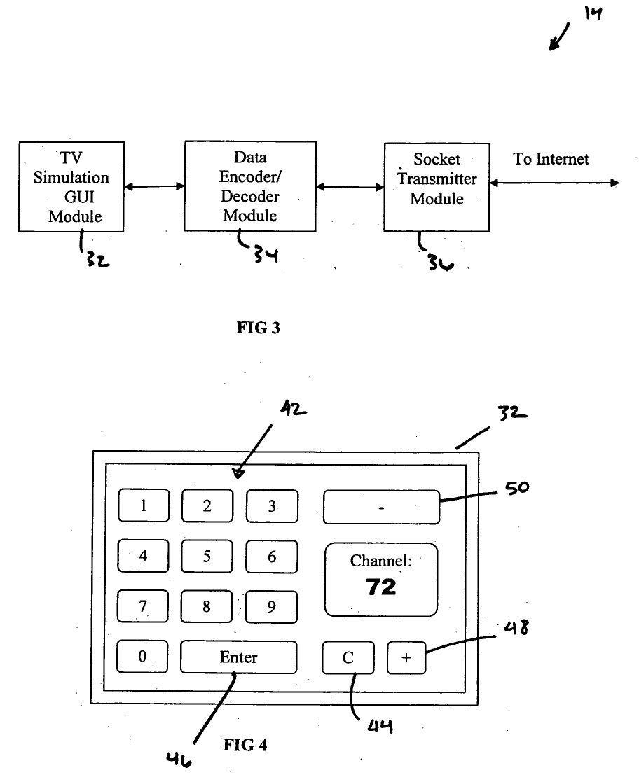

FIG. 3 illustrates a structure for the client module 14. It shows the client module 14 includes: a TV simulation GUI module 32, a data encoder/decoder module 34 and a socket transmitter module 36. The TV simulation GUI module 32 emulates the functions of a TV. It renders the video/audio stream from the client side 14; and on the other hand, it allows the user to issue the control commands such as TV channel scanning, TV channel switch, TV channel increase and decrease, color adjustment, etc. to the host 12 to remote control the TV tuner device on the host side 12. The data encoder/decoder module 34 encodes the command data into a message datagram (CP datagram), which the user inputted, and decodes the video/audio stream from the host side 12. The socket transmitter module 22 sends client data to the host side 12 and receives the data from the host side 12.

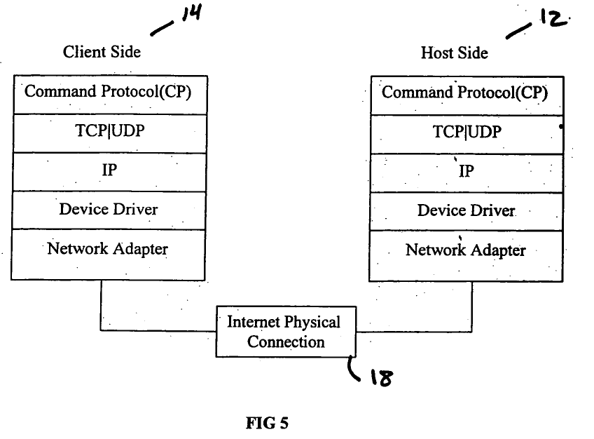

FIG. 4 shows the TV tuner simulation GUI 32, it simulates the TV tuner remote control. A user can use it to input a control command. The number keys 42 are for the user to input the channel; the “c” key 44 is for the user to erase one digit of input. The “Enter” key 46 is to let user confirm the inputted TV channel. The “+” and “−” 48, 50 key allow user increase or decrease channel.

The client talks to the host using TCP/IP or UDP/IP, on an extra layer added over the TCP or UDP layer. This is referred to as the command protocol (CP).

FIG. 5 shows the communication stacks. The command protocol (CP) lies above the TCP or UDP, one or more CP data packets can be raw data of TCP or UDP to be transmitted.

The structure of the CP header is:

Struct CPacketH_t {

USHORT msgId; //2
USHORT msgLen; //2
ULONG srcAddr; // 4 source IP address
ULONG dstAddr; //4 destination IP address
USHORT tranNum; //2 Transaction number
UCHAR * pData; // msgLen − 14: data

}.

msgId: Message Id tag of data packet. msgId is message Id tag predefined, we predefined following message Ids:

#define REQ_CH_TVCHAN 0×101B
// Data 0:0-AutoTune, 1->Increase channel, 2->Decrease channel, 3->Set
// If Data 0 is 3, Data 1 is the channel number to be set 0-0×FF.

This message is used to let the client change the TV channel, the first byte of pData is operation code, if the operation code is 0, the host side TV tuner will start to scan TV channels; if the operation code is 1, the host side TV tuner will increase one channel; if the operation code is 2, the host side TV Tuner will decrease one channel; if the operation code is 3, the host side TV Tuner will switch to the TV channel defined in the second byte of the pData.

#define RSP_CH_TVCHAN 0×101C
//Data 0: 0: operate OK, 1: operation failed

The host module 12 uses this message to inform the client 14 of the result of the previous operation. If the first byte of the pData is 0, the previous operation succeeded, else it failed.

MsgLen: the total data length of the datagram. This section usually will be written after the data has been prepared. The maximum length of a datagram is 65500 bytes.

srcAddr: Source IP address. This section contains the source IP address of the datagram. Normally the format of IP is xxx.xxx.xxx.xxx. This is converted section-by-section to hex, so the value is 0xffffffff and a unsigned long type data can hold it.

dstAddr: Target IP address. This section contains the target 1P address, the format is same as the source IP address.

tranNum: sequence number of the datagram. This section contains the transaction number of the packet. It is used for verifying previous data packets if there is any packet lost.

pData: the data block of the datagram. This is the data part of the datagram. Its length is msgLen—14, where 14 is the length of the datagram header.

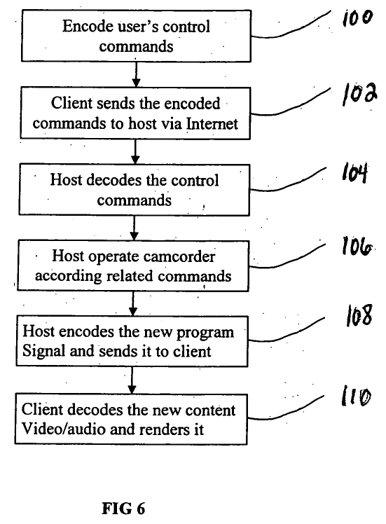

FIG. 6 is a flowchart illustrating a method embodiment of the invention that may include the following:
100: Client encodes the control command;
102: Client sends the encoded datagram to the host side over the Internet;
104: Host receives the datagram, decodes it and gets the original command;
106: Host operates the TV tuner according the control command;
108: Host encodes the new program signal and sends it to the client side;
110: Client decodes the new video/audio signal and renders it.

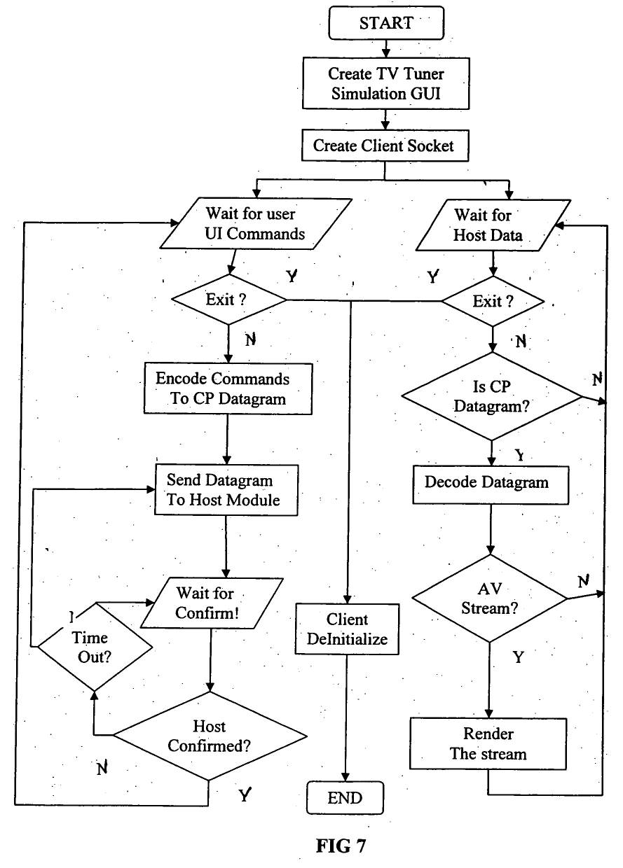

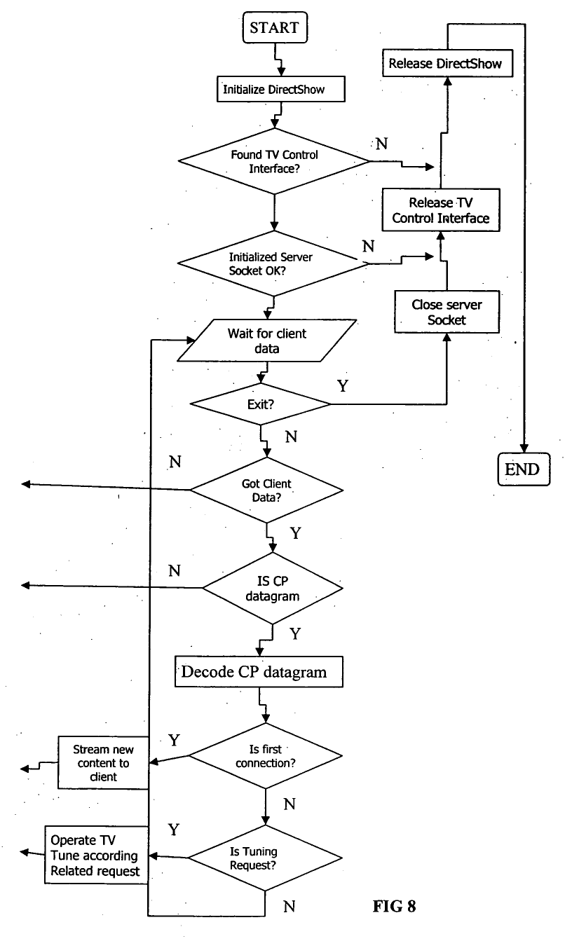

FIG. 7 and FIG. 8 illustrate further detail of the embodiment shown in FIG. 6. The flowcharts show the procedures of the host side 12 processing and the client side 14 processing. The client module 14 involves the following:
Initialize the client socket with the host IP and the host port;
Create simulation GUI; initialize the audio/video render for the coming stream;
If user interact with the control of the GUI, client encodes the command and send it to the host module;
If get incoming video/audio stream, client module renders it.

The host module 12 involves the following:
Initialize DirectShow component, find the device moniker of the TV tuner device;
Create the CaptureBuilder2 interface and construct the filter graph;
Bind the TV device moniker with the filter;
Bind the filter graph with the CaptureBuilder2;
Add the TV capture filter to the graph;
Find the TV tuner control interface (IID_IAM_TVTuner);
Create server socket, listening to the client's connection;
If the client is connected to the socket, run the graph and stream the video/audio to the client;
If received a client's channel adjust message, call the related method such as put_channel of the TV control interface to response the client's request and send the client the message of the result of the executing.

The invention uses remote control technology and method via network and has the following positive effects:

Easy to operate and easy to extend function. It is very convenient and flexible by using the remote controlling via the network. It makes the using of TV Tuner devices much more convenient, and eliminates the barrier of distance and manual control input.

Easy to implement, the platform is same as the concurrent remote controlling platform and the operation system used is the common OS as well.

1. A system comprising:
a client module and a host module connected to each other a TCP/IP network;
the host module having a TV tuner device, the TV tuner device connected to a TV program source, the host module being able to receive and decode control commands from the client module received via the network and to operate the TV tuner device in accordance with the control commands, the host module further operable to generate a video/audio stream of a TV program from the TV program source for the client module;
the client module being operable to send the control commands to the host module over the network, and to render the audio/video stream data from the host module through the network; and
the host module and the client module being coupled to communicate using TCP/IP protocol.

2. The system according to claim 1, the host module comprising:
a socket transmitter module, a data encoder/decoder module and a TV tuner control module;
the socket transmitter module operable to receive the control commands from the client module and to pass these commands to the data encoder/decoder module; and to transfer the encoded audio video stream to the client module over the network; and
a data encoder/decoder module being operable to decode the control commands from the socket transmitter module, and to cause the TV tuner control module to commit a related operation according to the command; and to encode the TV program for the socket transmitter module;
the TV tuner control module being operable to implement the operation according the decoded control commands and to read the encoded TV program.

3. The system of claim 1, the client module comprising:
a TV simulation module, a data encoder/decoder module and a socket transmitter module;
the TV simulation module being operable to enable a user to input the control commands and to render the video/audio stream from the host module;
the data encoder/decoder module operable to assemble the user control commands into a datagram and to enable the socket transmitter module to send the datagram to the host module, and to decode the video/audio stream from the host side;
the socket transmitter module being operable to send the datagram to the host module and to receive the video/audio stream data from the host over the network.

4. The system of claim 1, the control commands comprising:
TV channel scanning, direct channel inputing, channel increasing or channel decreasing.

5. The system of claim 1, the TV program source comprising a microware TV, CATV, cable or satellite TV signal source.

6. The system of claim 1, the network being wired or wireless.

7. A method of remotely controlling a TV tuner comprising:
coupling a host side and a client side via a network;
providing a host side computer having a TV tuner device and connecting the TV device to a TV signal source;
encoding a control command;
sending the encoded control command to the client side through the network;
receiving on the host side from the client side an encoded control command and decoding it;
executing an operation according the encoded control command;
streaming new content data to the client side over the network; and
rendering the new content data.

8. The method of claim 7 comprising at least one of:
TV channel scanning, TV channel direct inputting, TV channel increasing and TV channel decreasing.

9. The method of claim 7 comprising after executing the operation, sending the client side a response message to report the result of the operation.

10. The method of claim 9 the response message containing a flag showing whether the previous operation succeeded or not.

11. The method of claim 7 comprising generating a datagram of the control command, the datagram comprising a data head section and a data section; the data head section containing a message ID section, a data length section, a source IP address section, a destination IP address section and a transaction number section.

12. The method of claim 7, the network media being wired or wireless.

13. The method of claim 7 comprising:
initializing a client socket with a host IP and a host port;
creating a simulation GUI; new line initializing the content data rendering for the stream;
if the user inputs a control command, receiving the control command from the GUI, encoding the control command and sending it to the host module; and
if receiving the new content data stream, rendering the new content data.

14. The method of claim 8 comprising:
initializing a DirectShow component, and finding a device moniker of the TV tuner device;
creating a CaptureBuilder2 interface and constructing a filter graph;
binding the TV tuner device moniker with the filter graph;
binding the filter graph with the CaptureBuilder2;
adding a TV capture filter to the filter graph;
finding a TV tuner control interface;
creating a server socket, and listening to the client side connection; and
if the client side is connected to the socket, running the filter graph and streaming the content data to the client side; and
upon receiving a control command, executing the control command.
